(19) United States
(12) Patent Application Publication
(10) Pub. No.: US 2022/0389281 A1
(43) Pub. Date: Dec. 8, 2022

(54) ELECTRICAL STEEL STRIP OR SHEET, METHOD FOR PRODUCING SUCH AN ELECTRICAL STEEL STRIP OR SHEET, AND LAMINATED CORE MADE THEREFROM

(71) Applicant: voestalpine Stahl GmbH, Linz (AT)

(72) Inventors: Ronald FLUCH, Linz (AT); Hector MENDEZ, Linz (AT)

(21) Appl. No.: 17/777,173

(22) PCT Filed: Nov. 16, 2020
(86) PCT No.: PCT/EP2020/082309

§ 371 Date: May 16, 2022

(30) Foreign Application Priority Data
Nov. 15, 2019 (EP) 19209572.7

(51) Int. Cl. C09J 7/28; C09J 7/35; C09J 11/04; C09J 11/06; C09J 163/10; C09J 5/02; C09J 5/06; B32B 7/12; B32B 7/025; B32B 15/01; B32B 37/12

(52) U.S. Cl. CPC C09J 7/28; C09J 7/35; C09J 11/04; C09J 11/06; C09J 163/10; C09J 5/02; C09J 5/06; B32B 7/12; B32B 7/025; B32B 15/011; B32B 37/1207; C09J 2203/326; C09J 2301/304; C09J 2301/314; C09J 2301/408; C09J 2301/416; C09J 2400/163; C09J 2400/166; B32B 2037/1215; B32B 2307/202; B32B 2311/30

(57) ABSTRACT

An electrical steel strip or sheet with a thermosetting water-based hot-melt adhesive varnish layer provided on at least one of its flat sides, a method for producing such an electrical steel strip or sheet, and a laminated core made therefrom are disclosed. In order to produce a particularly storable and aging-stable thermosetting hot-melt adhesive varnish layer on the electrical steel strip or sheet in the B state, it is proposed for the stoichiometric ratio of the epoxy groups of the epoxy resin or epoxy resins relative to the hydrogen atoms of the at least two amino groups of the hardener that is latent at room temperature to lie in the range from 1.33:1 to 5:1.

### TECHNICAL FIELD

The invention relates to an electrical steel strip or sheet with a thermosetting water-based hot-melt adhesive varnish layer provided on at least one of its flat sides, having an epoxy resin or a mixture of different epoxy resins and a hardener that is latent at room temperature and has at least two amino groups, which are primary and/or secondary amino groups; a method for producing such an electrical steel strip or sheet; and a laminated core made therefrom.

### PRIOR ART

Numerous methods are known from the prior art for adhesive coating the surface of an electrical steel strip or sheet in order to integrally bond sheet metal parts detached therefrom to one another to form a laminated core. This is achieved, among other things, by using water-based thermosetting hot-melt adhesive varnishes, i.e. reactive adhesive systems with hot-melt adhesive—also referred to as backlacks. Such water-based thermosetting hot-melt adhesive varnishes are applied as a coating to an electrical steel strip or sheet (EP3072936A1) and by means of drying, i.e. the removal of water and possibly present solvents and cosolvents from the hot-melt adhesive varnish layer, are transformed from the A state into the B state. In the B state, the hot-melt adhesive varnish layer on the electrical steel strip or sheet thus remains bondable by means of thermosetting.

Then, sheet metal parts that have been detached from such an electrical steel strip or sheet are stacked on top of one another and by means of a so-called baking process are first brought to the bonding state and then to the hardening state—i.e. are integrally bonded to one another to form laminated cores by means of the parameters of pressure, temperature, and time.

One problem that is addressed by the prior art relates to the storage of coated electrical steel strips or sheets in the B state. In a water-based thermosetting hot-melt adhesive varnish layer, reactions of the latent hardener with epoxy resin do in fact occur relatively slowly at temperatures of around 35° C.—especially if this layer does not contain any accelerants —, but at temperatures above this, such reactions can be expected to occur more quickly. The inventors have surprisingly discovered that even with a storage temperature at room temperature, the further processability of electrical steel strips or sheets in the B state can deteriorate significantly even after only a few months. This effect has not yet been completely explained and can also be promoted by epoxy resin/hardener oligomers that can form in the hot-melt adhesive varnish layer in the course of the drying for achieving the B state—i.e. in the manner of a “pre-polymerization.”

In the course of the storage of electrical steel strips or sheets in the B state, long-chain oligomers form, which lead to an undesirable cold hardening with correspond-ingly adverse effects on the further bonding capacity of the hot-melt adhesive varnish layer in the B state.

In order to still insure the best possible bondability and in order to be able to subsequently produce high-strength laminated cores with outstanding magnetic properties even after numerous months of storage and/or after an increase of the temperature to above room temperature in the course of transport, the prior art proposes, for example, including fillers in the hot-melt adhesive varnish.

### DISCLOSURE OF THE INVENTION

The object of the invention based on the prior art explained at the beginning is to furnish an electrical steel strip or sheet, which has a thermosetting water-based hot-melt adhesive varnish layer provided on at least one of its flat sides, and to furnish such electrical steel strips or sheets whose bonding capacity is adjustable in a reproducible way after the drying of the applied hot-melt adhesive varnish layers—and which bonding capacity remains as stable as possible even over periods of several months and possibly after being exposed to elevated temperatures in the vicinity of 60° C. during its transport.

The invention attains the stated object with regard to the electrical steel strip or sheet by means of the features of claim 1.

If the stoichiometric ratio of the epoxy groups of the epoxy resin or epoxy resins relative to the hydrogen atoms of the at least two amino groups of the latent hardener is in the range from 1.33:1 to 5:1—i.e. if the hydrogen atoms of the amino groups of the latent hardener are substoichiometric in relation to the epoxy groups of the epoxy resin or epoxy resins—then a possibly occurring reaction of the hardener with epoxy groups of the epoxy resin or epoxy resins in the thermosetting water-based hot-melt adhesive varnish layer can be selectively adjusted so that a hot-melt adhesive varnish layer is furnished in which such—undesirable—reactions are accompanied by significantly fewer negative effects on the further storability of the electrical steel strip or sheet according to the invention.

Surprisingly, by means of the above-mentioned substoichiometric ratio of the hydrogen atoms in relation to the epoxy groups, it is nevertheless possible to insure a suf-ficient bondability.

One factor in this connection is the short chain lengths produced according to the invention or more precisely, the reduction—during storage—in the chain lengthening of molecules of hardener and epoxy that may possibly bond with one another in the thermosetting water-based hot-melt adhesive varnish layer.

It can be assumed that because of the above-mentioned substoichiometric ratio of the hydrogen atoms—and the resulting statistical conditions—reactions possibly occurring in the hot-melt adhesive varnish layer above room temperature can be selectively steered toward oligomers of individual dicyandiamide molecules with up to two epoxy resin molecules each. By contrast, it is thus possible to avoid a bonding of such oligomers with other hardener molecules and/or such oligomers—i.e. the formation of viscosity-increasing, long-chain oligomers of multiple dicyandiamide molecules with numerous epoxy resin molecules.

This especially also applies to a temperature increase during the application of the thermosetting water-based hot-melt adhesive varnish layer to the electrical steel strip or sheet and/or during the subsequent drying thereof.

Long-chain oligomers of this kind induce an undesirable cold hardening of the hot-melt adhesive varnish layer in the B state, in other words, they adversely affect the storage stability among other things. The undesirable chain lengthening induces a poorer melting of the hot-melt adhesive varnish layer and results in a reduced cross-linking during the bonding process.

Surprisingly, it especially turns out that it is not only possible to achieve a particularly high storage stability and thus storability of the hot-melt adhesive varnish layer on the electrical steel strip or sheet according to the invention after it has been dried, but it is also possible, after thermal activation of the hardener, for there to be an even higher cross-linking density and thus an improved hardening of the hot-melt adhesive varnish together with an increased adhesive strength on the electrical steel strip or sheet. In the end, this manifests itself in an increased bonding strength and in an improved roller peel resistance of the hardened hot-melt adhesive varnish layer.

In particular, the stoichiometric ratio of the epoxy groups of the epoxy resin or epoxy resins relative to the hydrogen atoms of the amino groups of the latent hardener can prove to be outstanding when it is in the range from 2.0:1 to 2.7:1.

Particularly advantageous results can be achieved if the stoichiometric ratio is in the range from 2.0:1 to 5:1. The range from 2.0:1 to 4:1 in particular also exhibits a reproducible increase in the bonding strength.

In general, it is assumed that a suitable latent hardener is an epoxy hardener, which, at least at room temperature, is practically inert relative to the epoxy resin—and reacts with it as rapidly as possible only at a temperature of particularly greater than 100° C. during the bonding process, i.e. upon achievement of its activation temperature.

Room temperature is assumed to be at most 30° C. Above this temperature, a slow, but continuously occurring reaction of the latent hardener with the epoxy resin does in fact happen—which is undesirable. Preferably, the hardener is latent at a temperature of up to 30° C.

Advantageously, the epoxy resin molecules of the epoxy resin have on average 1 to 3 epoxy groups per 1000 g of their molar mass or the epoxy resin molecules of the mixture of different epoxy resins have on average 1 to 3 epoxy groups per 1000 g of their average molar mass.

In this way, the above-mentioned advantages can be insured in a particularly reproducible way. This feature particularly brings out the effects and advantages of the stoichiometric ratio of epoxy groups of the epoxy resin or of the different epoxy resins relative to the hydrogen atoms of the amino groups of the latent hardener. One reason for this can be identified in the fact that possible reactions can be even more selectively steered toward the formation of oligomers of individual dicyandiamide molecules with up to two epoxy resin molecules each—whereas for example reactions with epoxy resins, which have a higher number of epoxy groups per 1000 g of their molar mass compared to the invention, tend to form such oligomers with more epoxy resin molecules.

Especially the more pronounced spatial isolation of a dicyandiamide molecule due to an epoxy resin that is bonded to it may play a significant role in this connection. This provides better avoidance of a bonding of such oligomers with other molecules of the latent hardener and/or of such oligomers with one another and/or with hardener molecules that have formed a bond with a pre-crosslinking agent molecule.

This can also have an impact in addition to the effects of a pre-crosslinking agent that may possibly be present in the thermosetting water-based hot-melt adhesive varnish layer.

For this purpose, the epoxy resin molecules of the epoxy resin preferably have 2 to 3 or 1.5 to 2.5 epoxy groups per 1000 g of their molar mass or the epoxy resin molecules of the mixture of different epoxy resins have an average of 1 to 2.5 epoxy groups per 1000 g of their average molar mass. In relation to the epoxy resin molecules of the mixture of different epoxy resins, 1.5 to 2.5 epoxy groups per 1000 g of their average molar mass can be particularly outstanding with regard to the above-mentioned advantages.

Advantages with regard to reproducibility and also with regard to production costs can be achieved if the epoxy resin is based on bisphenol. A basis of bisphenol A, bisphenol B, bisphenol C, bisphenol D, bisphenol E, or bisphenol F, or an arbitrary mixture thereof can be outstanding for this purpose.

If the epoxy groups of the epoxy resin molecules are terminally positioned on the epoxy resin molecules, then a particularly stable hot-melt adhesive varnish layer can be achieved with regard to the above-mentioned advantages with regard to the stoichiometric ratio of the epoxy groups of the epoxy resin or of the different epoxy resins relative to the hydrogen atoms of the amino groups of the latent hardener. Specifically, it is thus possible to achieve the largest possible spatial distance of the epoxy groups from one another, which contributes to the above-mentioned spatial isolation. In this way, it is also possible to improve the effects of a possibly present pre-crosslinking agent. It is possible for in particular more than 80%, preferably all, of the epoxy groups of the epoxy resin molecules to be terminally positioned on the epoxy resin molecules.

The above-mentioned advantages are particularly achievable or occur in a particularly reproducible way if the latent hardener has exactly two primary amino groups. In this case, there are thus two amino groups with essentially the same reactivity relative to epoxy groups of the epoxy resin molecules. Specifically in a possibly occurring chain lengthening, it is thus possible to selectively achieve one with a maximum chain length of two epoxy resin molecules and one hardener molecule—namely one epoxy resin molecule per primary amino group of the latent hardener.

The latent hardener is advantageously based on cyanamide, which among other things, is accompanied by comparatively low costs.

Dicyandiamide is particularly suitable since at least at room temperature, it is practically inert relative to an epoxy resin—provided that no accelerant is present in the hot-melt adhesive varnish layer. In addition, the above-mentioned possibly occurring chain formation of dicyandiamide with epoxy resin can be controlled particularly well below the activation temperature due to its chemical structure. Such reactions with epoxy resin molecules occur more or less exclusively at the primary amino group(s) of the dicyandiamide, which has a significantly elevated reactivity—in comparison to its other amino groups.

It is thus possible to insure in a particularly reliable way that—even with a subsequently produced electrical steel strip or sheet in the B state according to the invention and even when stored over several months and possibly after being exposed to elevated temperatures, even in the vicinity of 60° C., during its transport—where re-quired, only reactions up to the above-mentioned maximum chain length of two epoxy resin molecules with a dicyandiamide molecule occur. The above-mentioned advantageous effects can therefore be achieved particularly well by means of dicyandiamide.

A reliable, inexpensive, and particularly simple adjustment of the stoichiometric ratio according to the invention is also possible if dicyandiamide is contained as the sole latent hardener in the water-based and subsequently dried thermosetting hot-melt adhesive varnish layer.

The above-mentioned advantages can be achieved more particularly with a thermosetting water-based hot-melt adhesive varnish layer that has:
35 to 55 wt %, more particularly 40 to 50 wt %, of an epoxy resin or a mixture of different epoxy resins with an average molar mass of 1000 to 2000 g/mol and
0.15 to 1.0 wt %, more particularly 0.4 to 0.6 wt %, of the latent hardener, more particularly dicyandiamide.

If the thermosetting hot-melt adhesive varnish layer also has an organic triamine as a pre-crosslinking agent that bonds with epoxy resin at room temperature, then the effect according to the invention of the stoichiometric ratio of epoxy groups of the epoxy resin or epoxy resins relative to the hydrogen atoms of the amino groups of the latent hardener can be particularly outstanding.

Suitable pre-crosslinking agents particularly include organic triamines, more particularly those that have three primary amino groups. By means of these, a pre-crosslinking, i.e. a reaction of the amino groups of the pre-crosslinking agent with reactive epoxy groups of different epoxy resin molecules of the epoxy resin to form secondary and/or tertiary amines, i.e. comparatively voluminous compounds, can occur in the thermosetting water-based hot-melt adhesive varnish layer—but have no negative effects on the further bonding capacity.

Such a pre-crosslinking can be adjusted with particular ease and stability with the aid of the pre-crosslinking agent and the above-mentioned stoichiometric ratio so that the melting viscosity of the thermosetting hot-melt adhesive varnish layer in-creases—thus preventing an outflow of the hot-melt adhesive varnish during an integral bonding, for example in the course of a baking process when sheet metal parts have been assembled to form a laminated core. In this connection, the above-mentioned effects and advantages of the stoichiometric ratio of epoxy groups of the epoxy resin or epoxy resins relative to the hydrogen atoms of the amino groups of the latent hardener are particularly brought out since this insures that—as mentioned above—the reaction is selectively steered toward oligomers of individual dicyandiamide molecules with up to two epoxy resin molecules each. By contrast, a bonding of such oligomers with other molecules of the latent hardener and/or of such oligomers with one another and/or with hardener molecules that have formed a bond with a pre-crosslinking agent molecule can be avoided to an improved degree. An undesirable impairment of the effects achieved with the pre-crosslinking agent can thus be selectively prevented—and the above-mentioned advantages according to the invention with regard to the storage stability and storability as well as bonding capacity of the hot-melt adhesive varnish layer and its adhesive strength on the electrical steel strip or sheet persist. In fact, it is even possible to observe a syner-gistic effect of the stoichiometric ratio according to the invention with the effects of the pre-crosslinking agent.

It is thus possible to better insure the stability of the dispersion of the thermosetting water-based hot-melt adhesive varnish during its storage, while it is being applied to an electrical steel strip or sheet, while it is being dried, and/or while it is being stored in the B state at room temperature—and even in the case of elevated temperatures, for example during transport, which can easily reach 60° C.

The above-mentioned advantages can be achieved more particularly with a thermosetting water-based hot-melt adhesive varnish layer that has:
35 to 55 wt %, more particularly 40 to 50 wt %, of the epoxy resin or mixture of different epoxy resins with an average molar mass of 1000 to 2000 g/mol,
0.1 to 2 wt %, more particularly 0.2 to 1.0 wt %, of triamine as a pre-crosslinking agent with an average molar mass of 350 to 550 g/mol, and
0.15 to 1.0 wt %, more particularly 0.4 to 0.6 wt %, of the latent hardener, more particularly dicyandiamide.

An average molar mass of 1000 to 2000 g/mol is appropriate for both the epoxy resin and the mixture of different epoxy resins.

It is possible for the thermosetting water-based hot-melt adhesive varnish layer to have a filler, more particularly 5 to 15 wt %, preferably 7.5 to 10 wt %, which filler is a metal carbonate, metal sulfate, metal sulfide, metal silicate, or metal phosphate, or an arbitrary mixture thereof. More particularly, conceivable fillers of this kind can be: calcium carbonate (CaCO₃), barium sulfate (BaSO₄), zinc sulfide (ZnS), magnesium silicate (MgO₃Si) or aluminum silicate, and zinc phosphate Zn₃(PO₄)₂. In addition, average grain sizes of 0.6 to 3 μm are particularly suitable. In this way, for example an additionally increased storage stability of the thermosetting hot-melt adhesive varnish layer and of an article subsequently made of this electrical steel strip or sheet can be achieved with this completely cross-linked backlack layer, which has a particularly high stability.

Preferably, the thermosetting water-based hot-melt adhesive varnish layer can contain a residue of water and, more particularly 4 to 20 wt %, of a cosolvent, preferably a cosolvent in the form of 1-methoxy-propanol. This results in a particularly simple and inexpensive composition of this hot-melt adhesive varnish layer. Through the use of the above-mentioned cosolvent it is possible to achieve a better incorporabil-ity of the resin and hardener—without adversely affecting the above-mentioned advantages according to the invention.

The advantages according to the invention—as has already been mentioned above—are also particularly brought out in an electrical steel strip or sheet with a dried thermosetting hot-melt adhesive varnish layer provided on at least one of its flat sides.

The procedure of such a drying can take place more particularly at a sheet temperature of 180 to 280° C. Usually, such a drying can be presumed to be of a relatively short duration—including heating, it takes less than a minute and is preferably ap-prox. 20-35 seconds. Preferably, the drying process takes place with a maximum strip temperature of 180-220° C. If the hot-melt adhesive varnish layer is free of accelerants, then these drying parameters—temperature and duration—are not suffi-cient for an activation of the hardener.

This furnishes an electrical steel strip or sheet with a thermosetting hot-melt adhesive varnish layer—i.e. a hot-melt adhesive varnish layer in the B state—which is particularly rugged—more particularly with a longer storage time over several months and especially also in the event of a temperature elevation during transport, which experience has shown can be up to 60° C. This advantage manifests itself among other things in an increase of the bonding strength of the hot-melt adhesive varnish layer according to the invention, which is also evident based on the roller peel resistance after completion of its hardening and bonding.

A particularly outstanding option for this can be a thermosetting hot-melt adhesive varnish layer, which is more particularly dried at a strip temperature of 180 to 280° C. and has:
75 to 92.8 wt %, more particularly 80 to 90 wt %, of the epoxy resin or mixture of different epoxy resins with an average molar mass of 1000 to 2000 g/mol,
0.3 to 2 wt %, more particularly 0.8 to 1.2 wt %, of the latent hardener, more particularly dicyanamide,
   and a residue more particularly of water and cosolvent, preferably a cosolvent in the form of 1-methoxy-propanol. An average molar mass of 1000 to 2000 g/mol is appropriate for both the epoxy resin and the mixture of different epoxy resins.

A preferred electrical steel strip or sheet with regard to the above-mentioned advantages can be one whose thermosetting hot-melt adhesive varnish layer, which is more particularly dried at a strip temperature of 180 to 280° C., has:
75 to 92.8 wt %, more particularly 80 to 90 wt %, of the epoxy resin or mixture of different epoxy resins with an average molar mass of 1000 to 2000 g/mol,
0.2 to 4 wt %, more particularly 0.4 to 2 wt %, triamine as a pre-crosslinking agent with an average molar mass of 350 to 550 g/mol,
0.3 to 2 wt %, more particularly 0.8 to 1.2 wt %, of the latent hardener, more particularly dicyanamide,
   and a residue more particularly of water and cosolvent, preferably a cosolvent in the form of 1-methoxy-propanol.

In addition, an electrical steel strip or sheet that turns out to be advantageous with regard to an improvement of the storability can be one whose thermosetting hot-melt adhesive varnish layer, which is more particularly dried at a strip temperature of 180 to 280° C., has:
50 to 82.8 wt %, more particularly 65 to 80 wt %, of the epoxy resin or mixture of different epoxy resins with an average molar mass of 1000 to 2000 g/mol,
10 to 25 wt %, more particularly 15 to 20 wt %, of the filler, 0.3 to 2 wt %, more particularly 0.8 to 1.2 wt %, of the latent hardener, more particularly dicyanamide,
optionally 0.2 to 4 wt %, more particularly 0.4 to 2 wt %, of triamine as a pre-crosslinking agent with an average molar mass of 350 to 550 g/mol,
   and a residue of water and a cosolvent, more particularly 1-methoxy-propanol.

An above-mentioned coated electrical steel strip or sheet, whose thermosetting hot-melt adhesive varnish layer is more particularly dried at a strip temperature of 180 to 280° C., is reduced in its water and cosolvent content—provided that such a cosolvent was contained in the thermosetting water-based hot-melt adhesive varnish layer before the drying. In other words, the only residue of water and cosolvent that can be contained is one that either does not escape or that materializes under the drying conditions that are used. In this connection, depending on the drying conditions, the total percentage of water and/or cosolvent in the thermosetting hot-melt adhesive varnish layer is at most 24.7 wt %, but is more particularly in the range from 5 to 8 wt %. In such a B state, storability and storage stability can be achieved in a particularly reliable way.

In terms of the method, an electrical steel strip or sheet according to the invention can be produced in a simple way through an application, more particularly roller application or spray application, of the thermosetting water-based hot-melt adhesive varnish on at least one flat side of the electrical steel strip or sheet.

Another object of the invention is to furnish a method for producing a laminated core from an electrical steel strip or sheet, which is simple to carry out and permits an adhesion with a particularly high cross-linking density. In addition, no outflow of the hot-melt adhesive varnish during the integral bonding should occur and there should be no adverse impact on the advantageous effects of a possibly present pre-crosslinking agent.

The invention attains the object with regard to the method based on the features of claim 19.

To achieve this, the hot-melt adhesive varnish layer of the electrical steel strip or sheet according to the invention is dried, more particularly at a strip temperature of 180 to 280° C., sheet metal parts are detached from the electrical steel strip or sheet, the sheet metal parts are stacked to form a laminated core, and the lam inat-ed core is bonded, more particularly through thermal activation of the hot-melt adhesive varnish layer, preferably at 100° C. to 250° C.

It has turned out that because of the stoichiometric ratio according to the invention of epoxy groups of the epoxy resin or epoxy resins relative to the hydrogen atoms of the amino groups of the latent hardener, it is possible to produce a laminated core whose sheet metal parts are bonded to one another in a particularly stable way—especially even after a storage of the electrical steel strip or sheet that is coated according to the invention over several months and above room temperature, for example during its transport. The above-described effects of the invention result in the fact that because of the above-described effects according to the invention, in the end an increased cross-linking density in the hardened hot-melt adhesive varnish and a particularly high adhesive strength of the hot-melt adhesive varnish on the sheet metal parts are achieved. In addition, such laminated cores feature outstanding magnetic properties.

Furthermore, the laminated cores obtained, based on the electrical steel strips and sheets that are available thanks to the invention, can be produced simply, reliably, and inexpensively.

### BRIEF DESCRIPTION OF THE DRAWINGS

In the following, the invention will be demonstrated by way of example based on a plurality of embodiments:

FIG. 1 shows the comparison of the invention to an exemplary embodiment from the prior art

FIG. 2 shows the comparison of the effects according to the invention based on two additional examples.

### WAY TO IMPLEMENT THE INVENTION

### Exemplary Embodiment 1 (EE1)

Exemplary embodiment 1 relates to a silicon-alloyed (for example 3% Si) electrical steel strip with a thermosetting water-based hot-melt adhesive varnish layer provided on one of its flat sides, which was applied by roller application in a layer thickness of 5 μm—which hot-melt adhesive varnish layer has:

40.0 wt % epoxy resin with an average molar mass of 1000 g/mol
1.00 wt % dicyandiamide
9.00 wt % 1-methoxy-propanol
and a residue of water. Exemplary embodiment EE1 therefore does not contain other ingredients such as fillers. Also, no accelerants are provided.

In 100 grams of the recipe according to EE1, there are thus 40.0 grams of the epoxy resin with an average molar mass of 1000 g/mol—and thus 0.0400 mol of epoxy resin molecules, which epoxy resin molecules each have two epoxy groups.

These 100 grams of the recipe according to EE1 also contain 1.00 gram of dicyandiamide with a molar mass of 84.08 g/mol—consequently this example has 0.0119 mol of dicyandiamide molecules, with a total of 4 hydrogen atoms of the amino groups per dicyandiamide molecule.

In exemplary embodiment 1, the stoichiometric ratio of the epoxy groups of the epoxy resin to the hydrogen atoms of the amino groups of the dicyandiamide as a latent hardener is therefore 0.0800:0.0476, i.e. 1.68:1. This is within the stoichiometric ratio of claim 1, namely within the range of from 1.33:1 to 5:1.

In addition, the requirement of claim 4 is satisfied: The 0.0400 mol of epoxy resin molecules, which in exemplary embodiment EE1 have a molar mass of 1000 g/mol, have 0.0800 mol of epoxy groups—this yields an average of 2 epoxy groups per 1000 g of the molar mass of the epoxy resin.

After being applied in accordance with claim 14, the hot-melt adhesive varnish layer is dried at a strip temperature (PMT—peak metal temperature) of 220° C. This yields an electrical steel strip in the B state, which is coated with an essentially wa-ter-free and cosolvent-free thermosetting hot-melt adhesive varnish layer.

### Prior Art (PA1):

The known example PA1 is a silicon-alloyed (for example 3% Si) electrical steel strip with a thermosetting water-based hot-melt adhesive varnish layer provided on one of its flat sides, which was applied by roller application in a layer thickness of 5 μm—which hot-melt adhesive varnish layer has:

40.0 wt % epoxy resin with an average molar mass of 1000 g/mol
2.00 wt % dicyandiamide
9.00 wt % 1-methoxy-propanol
and a residue of water.

In 100 grams of the recipe according to PA1 there are thus 40.0 grams of the epoxy resin with an average molar mass of 1000 g/mol—and thus 0.0400 mol of epoxy resin molecules, which epoxy resin molecules each have two epoxy groups. These 100 grams of the recipe according to PA1 also contain 2.00 grams of dicyandiamide with a molar mass of 84.08 g/mol—consequently this example has 0.0240 mol of dicyandiamide molecules, with a total of 4 hydrogen atoms of the amino groups per dicyandiamide molecule.

In PA1, the stoichiometric ratio of the epoxy groups of the epoxy resin to the hydrogen atoms of the amino groups of the dicyandiamide as a latent hardener is therefore 0.0800:0.0960, i.e. 0.83 to 1. This is not within the stoichiometric ratio of claim 1, namely within the range of from 1.33:1 to 5:1.

After being applied, the hot-melt adhesive varnish layer is likewise dried at a strip temperature (PMT—peak metal temperature) of 220° C. This yields an electrical steel strip in the B state, which is coated with an essentially water-free and cosol-vent-free thermosetting hot-melt adhesive varnish layer.

### Comparison of Exemplary Embodiment 1 (EE1) to the Prior Art (PA1):

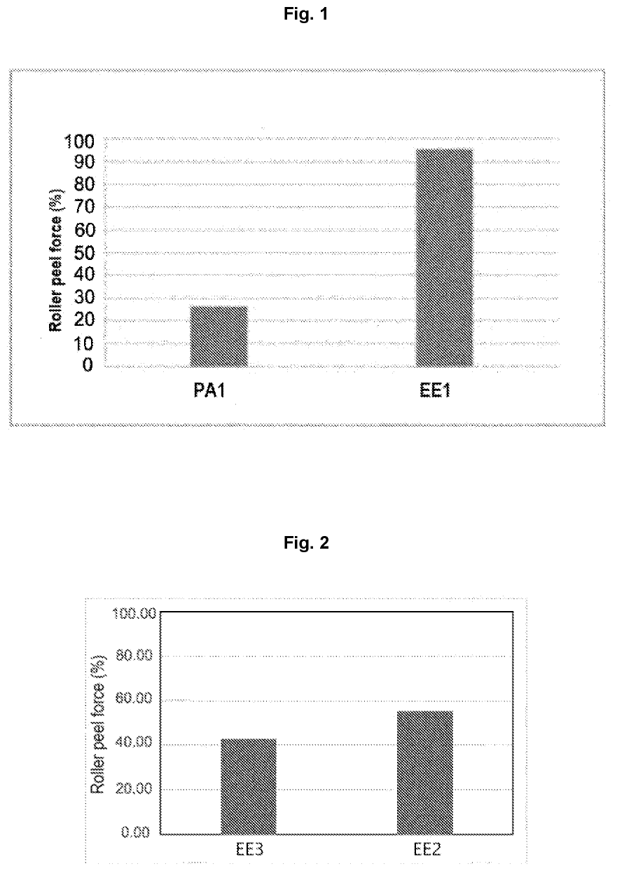

FIG. 1 shows the roller peel force of exemplary embodiment 1 (EE1) according to the invention compared to that of the prior art (PA1).

For this purpose, the electrical steel strips EE1 and PA1, which had been dried as mentioned above, were stored for 4 days at a strip temperature of 60° C. and were then cooled to room temperature. Then a hardening of the hot-melt adhesive varnish layer was carried out by means of thermal activation at 130° C. for 4 hours and with a mechanical pressure of 1 megapascal. The subsequent determination of the roller peel force was performed using the method according to the standard EN 1464.2010-02. The value 100 in FIG. 1 stands for the roller peel force of the electrical steel strips EE1 and PA1, which have been dried as mentioned above and then hardened as mentioned above—but without being stored above room temperature in the B state.

According to FIG. 1, there is a clear increase in the roller peel force for EE1—which means that the invention achieves a significantly smaller adverse effect on the adhesion force due to an elevated storage temperature.

### Exemplary Embodiment 2 (EE2)

Exemplary embodiment 2 relates to a silicon-alloyed (for example 3% Si) electrical steel strip with a thermosetting water-based hot-melt adhesive varnish layer provided on one of its flat sides, which was applied by roller application in a layer thickness of 5 μm—which hot-melt adhesive varnish layer has:
40.00 wt % epoxy resin with an average molar mass of 1000 g/mol
0.75 wt % dicyandiamide
0.75 wt % polyether triamine as a pre-crosslinking agent with the following struc-tural formula (brand name Jeffamine® T-403)

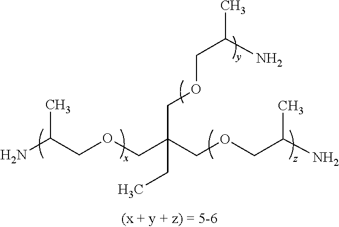

9.0 wt % 1-methoxy-propanol
   and a residue of water. Other ingredients such as fillers are conceivable, but accelerants are avoided.

In 100 grams of the recipe according to EE2, there are thus 40.00 grams of the epoxy resin with an average molar mass of 1000 g/mol—and thus 0.0400 mol of epoxy resin molecules, which epoxy resin molecules each have two epoxy groups. These 100 grams of the recipe according to EE2 also contain 0.75 grams of dicyandiamide with a molar mass of 84.08 g/mol—consequently this example has 0.0089 mol of dicyandiamide molecules, with a total of 4 hydrogen atoms of the amino groups per dicyandiamide molecule.

Without taking into account the other ingredients of the recipe from EE2, the stoichiometric ratio of the epoxy groups of the epoxy resin to the hydrogen atoms of the amino groups of the dicyandiamide as a latent hardener is therefore 0.0800:0.0357, i.e. 2.24:1. This is within the stoichiometric ratio of claim 1, namely within the range of from 1.33:1 to 5:1—and is within the preferred ranges of claims 2 and 3.

In 100 g of the recipe according to EE2 there are 0.75 g of Jeffamine® T-403. Jeffamine® T-403 has a molar mass of 440 g/mol—in exemplary embodiment EE2, the 6 hydrogen atoms of the primary amino groups per pre-crosslinking agent molecule of Jeffamine® T-403 yield 0.0102 mol of hydrogen atoms. On the assumption that all 0.0102 mol of the hydrogen atoms of the primary amino groups of the pre-crosslinking agent Jeffamine® T-403 react with epoxy groups of the epoxy resin in the A state or B state of the hot-melt adhesive varnish layer, i.e. in the thermosetting water-based hot-melt adhesive varnish layer or in the thermosetting dried hot-melt adhesive varnish layer, the number of the epoxy groups of the epoxy resin is reduced by the total number of hydrogen atoms of the primary amino groups of the pre-crosslinking agent. Taking into account the pre-crosslinking agent contained, 0.0698 mol of epoxy groups of the epoxy resin would still be present after this in exemplary embodiment EE2. This means that a stoichiometric ratio of the epoxy groups of the epoxy resin to the hydrogen atoms of the amino groups of the dicyandiamide as a latent hardener of 1.96:1 would still be present—the stoichiometric ratio of claim 1 is thus still satisfied.

Based on this assumption, the feature of claim 4 is likewise still satisfied: The 0.0400 mol of epoxy resin molecules, which in the exemplary embodiment have a molar mass of 1000 g/mol, have 0.0698 mol of epoxy groups—this yields an average of 1.745 epoxy groups per 1000 g of the molar mass of the epoxy resin.

The subsequent drying of exemplary embodiment 2 takes place in accordance with exemplary embodiment 1.

The same comparison test with regard to the roller peel force of EE2 was carried out as mentioned above—namely EE2 instead of EE1 in comparison to the prior art PA1.

Essentially the same result is apparent for EE2 as for EE1 in FIG. 1—which among other things demonstrates that the stoichiometric ratio according to the invention can be used even if a pre-crosslinking agent is present and more precisely, a pre-crosslinking agent does not exhibit any adverse effects on the above-mentioned advantages of the stoichiometric ratio.

### Exemplary Embodiment 3 (EE3)

Exemplary embodiment 3 relates to a silicon-alloyed (for example 3% Si) electrical steel strip with a thermosetting water-based hot-melt adhesive varnish layer provided on one of its flat sides, which was applied by roller application in a layer thickness of 5 μm—which hot-melt adhesive varnish layer has:
40.0 wt % epoxy resin with an average molar mass of 1000 g/mol, the epoxy resin molecules each having an average of two epoxy groups,
1.00 wt % dicyandiamide
1.25 wt % of the polyether triamine mentioned in EE2 as a pre-crosslinking agent (brand name Jeffamine® T-403)
9.00 wt % 1-methoxy-propanol
   and a residue of water. Other ingredients such as fillers are conceivable, but accelerants are avoided.

The recipe therefore corresponds to that of exemplary embodiment 1 (EE1)—but also contains the indicated pre-crosslinking agent.

The epoxy resin molecules in the recipe of EE3, as mentioned above, have an average molar mass of 1000 g/mol. They also have an average of 2 epoxy groups each, which in this exemplary embodiment 3 therefore yields 2 epoxy groups per 1000 g of the average molar mass of the epoxy resin molecules.

The 100 grams of the recipe according to EE3 also contain 1.00 gram of dicyandiamide with a molar mass of 84.08 g/mol—consequently, this example has 0.0119 mol of dicyandiamide molecules, with a total of 4 hydrogen atoms of the amino groups per dicyandiamide molecule.

Without taking into account the other ingredients of the recipe from EE3, the stoichiometric ratio of the epoxy groups of the epoxy resin to the hydrogen atoms of the amino groups of the dicyandiamide as a latent hardener is therefore 0.0800:0.0476, i.e. 1.68:1. This is within the stoichiometric ratio of claim 1.

In the 100 g of the recipe according to EE2, however, there are also 1.25 grams of Jeffamine® T-403. Jeffamine® T-403 has a molar mass of 440 g/mol—in exemplary embodiment EE2, the 6 hydrogen atoms of the primary amino groups per pre-crosslinking agent molecule of Jeffamine® T-403 yield 0.0170 mol of hydrogen atoms.

On the assumption that all 0.0170 mol of the hydrogen atoms of the primary amino groups of the pre-crosslinking agent Jeffamine® T-403 react with epoxy groups of the epoxy resin in the A state or B state of the hot-melt adhesive varnish layer, i.e. in the thermosetting water-based hot-melt adhesive varnish layer or in the thermosetting dried hot-melt adhesive varnish layer, the number of the epoxy groups of the epoxy resin is reduced by the total number of hydrogen atoms of the primary amino groups of the pre-crosslinking agent. In other words, 0.0630 mol of epoxy groups of the epoxy resin would still be present after this in exemplary embodiment EE2. This means that based on this assumption, a stoichiometric ratio of the epoxy groups of the epoxy resin to the hydrogen atoms of the amino groups of the dicyandiamide as a latent hardener of 1.32:1 is still present—based on this assumption, the stoichiometric ratio of claim 1 is no longer satisfied.

Based on this assumption, the feature of claim 4 is still satisfied: The 0.0400 mol of epoxy resin molecules, which in the exemplary embodiment have a molar mass of 1000 g/mol, have 0.0630 mol of epoxy groups—this yields an average of 1.575 epoxy groups per 1000 g of the molar mass of the epoxy resin.

The subsequent drying of exemplary embodiment 2 takes place in accordance with exemplary embodiment 1 (EE1).

After being applied in accordance with claim 14, the hot-melt adhesive varnish layer is dried at a strip temperature (PMT—peak metal temperature) of 220° C. An electrical steel strip in the B state, which is coated with an essentially water-free and cosolvent-free thermosetting hot-melt adhesive varnish layer, is thus obtained—this means that under the indicated drying conditions only residual water that has not escaped and cosolvent that has not escaped are still found in the thermosetting hot-melt adhesive varnish layer.

### FIG. 2:

FIG. 2 shows the comparison of the roller peel force of exemplary embodiment 2 (EE2) according to the invention and exemplary embodiment 3 (EE3).

For this purpose, the electrical steel strips EE2 and EE3, which had been dried as mentioned above, were stored for 7 days at a strip temperature of 60° C. and were then cooled to room temperature. Then a hardening of the hot-melt adhesive varnish layer was carried out by means of thermal activation at 130° C. for 4 hours and with a mechanical pressure of 1 megapascal. The subsequent determination of the roller peel force was performed using the method according to the standard EN 1464.2010-02.

The value 100 in FIG. 2 stands for the roller peel force of the electrical steel strips EE2 and EE3, which have been dried as mentioned above and then hardened as mentioned above—but without being stored for 7 days at the strip temperature of 60° C. in the B state.

According to FIG. 2, it is clear for EE2, which likewise has a pre-crosslinking agent, that its roller peel force is reduced to a less significant degree than that of EE3—which means that the invention achieves a significantly smaller adverse effect on the adhesion force due to an elevated storage temperature.

1. An electrical steel strip or sheet with a thermosetting water-based hot-melt adhesive varnish layer provided on at least one of its flat sides, comprising:
an epoxy resin or a mixture of different epoxy resins; and
a hardener that is latent at room temperature and has at least two amino groups, which are primary and/or secondary amino groups,
wherein a stoichiometric ratio of epoxy groups of the epoxy resin or epoxy resins relative to hydrogen atoms of the at least two amino groups of the latent hardener is in a range from 1.33:1 to 5:1.

2. The electrical steel strip or sheet according to claim 1, wherein the stoichiometric ratio is in a range from 2.0:1 to 2.7:1.

3. The electrical steel strip or sheet according to claim 1, wherein the stoichiometric ratio is in a range from 2.0:1 to 4:1.

4. The electrical steel strip or sheet according to claim 1, wherein epoxy resin molecules of the epoxy resin have on average 1 to 3 epoxy groups per 1000 g of their molar mass or the epoxy resin molecules of the mixture of different epoxy resins have on average 1 to 3 epoxy groups per 1000 g of their average molar mass.

5. The electrical steel strip or sheet according to claim 1, wherein the epoxy resin is based on bisphenol.

6. The electrical steel strip or sheet according to claim 1, wherein epoxy groups of the epoxy resin molecules are terminally positioned on the epoxy resin molecules.

7. The electrical steel strip or sheet according to claim 1, wherein the latent hardener has exactly two primary amino groups.

8. The electrical steel strip or sheet according to claim 1, wherein the latent hardener is based on cyanamide.

9. The electrical steel strip or sheet according to claim 1, wherein the thermosetting water-based hot-melt adhesive varnish layer has
35 to 55 wt % of the epoxy resin or of the mixture of different epoxy resins with an average molar mass of 1000 to 2000 g/mol and
0.15 to 1.0 wt % of the latent hardener.

10. The electrical steel strip or sheet according to claim 1, wherein the hot-melt adhesive varnish layer also has an organic triamine as a pre-crosslinking agent that bonds with epoxy resin at room temperature.

11. The electrical steel strip or sheet according to claim 10, wherein the thermosetting water-based hot-melt adhesive varnish layer has
35 to 55 wt % of the epoxy resin or of the mixture of different epoxy resins with an average molar mass of 1000 to 2000 g/mol,
0.1 to 2 wt % of triamine as a pre-crosslinking agent with an average molar mass of 350 to 550 g/mol, and
0.15 to 1.0 wt % of the latent hardener.

12. The electrical steel strip or sheet according to claim 1, wherein the thermosetting water-based hot-melt adhesive varnish layer optionally has a filler, which filler is a metal carbonate, metal sulfate, metal sulfide, metal silicate, or metal phosphate, or an arbitrary mixture thereof and has an average grain size of 0.6 to 3 μm.

13. The electrical steel strip or sheet according to claim 1, wherein the thermosetting water-based hot-melt adhesive varnish layer has a residue of water and a cosolvent in the form of 1-methoxy-propanol.

14. The electrical steel strip or sheet according to claim 1, wherein the thermosetting hot-melt adhesive varnish layer dried at a strip temperature of 180 to 280° C.

15. The electrical steel strip or sheet according to claim 14, wherein the thermosetting hot-melt adhesive varnish layer has:
75 to 92.8 wt % of the epoxy resin or of the mixture of different epoxy resins with an average molar mass of 1000 to 2000 g/mol,
0.3 to 2 wt % of the latent hardener,
and a residue of water and cosolvent.

16. The electrical steel strip or sheet according to claim 10, wherein the thermosetting hot-melt adhesive varnish layer is dried at a strip temperature of 180 to 280° C., and has:
75 to 92.8 wt % of the epoxy resin or of the mixture of different epoxy resins with an average molar mass of 1000 to 2000 g/mol,
0.2 to 4 wt % triamine as a pre-crosslinking agent with an average molar mass of 350 to 550 g/mol,
0.3 to 2 wt % of the latent hardener,
and a residue of water and cosolvent.

17. The electrical steel strip or sheet according to claim 12, wherein the thermosetting hot-melt adhesive varnish layer is dried at a strip temperature of 180 to 280° C., and has:
50 to 82.8 wt % of the epoxy resin or of the mixture of different epoxy resins with an average molar mass of 1000 to 2000 g/mol,
10 to 25 wt % of the filler,
0.3 to 2 wt % of the latent hardener,
optionally 0.2 to 4 wt % of triamine as a pre-crosslinking agent with an average molar mass of 350 to 550 g/mol,
and a residue of water and a cosolvent.

18. The electrical steel strip or sheet according to claim 14, wherein the thermosetting hot-melt adhesive varnish layer is free of water and cosolvents.

19. A method for producing the electrical steel strip or sheet according to claim 1, comprising a roller application or a spray application of the thermosetting water-based hot-melt adhesive varnish carried out on at least one flat side of the electrical steel strip or sheet.

20. The method for producing a laminated core with sheet metal parts of an electrical steel strip or sheet according to claim 19, including the steps:
drying the hot-melt adhesive varnish layer at a strip temperature of 180 to 280° C.,
detaching sheet metal parts from the electrical steel strip or sheet,
stacking the sheet metal parts to form a laminated core,
bonding the laminated core by thermal activation of the hot-melt adhesive varnish layer.

21. A laminated core produced with the method according to claim 20.

22. A laminated core produced from an electrical steel strip or sheet according to claim 1.
